(19) United States
(12) Patent Application Publication
(10) Pub. No.: US 2025/0013404 A1
(43) Pub. Date: Jan. 9, 2025

(54) PRINTING APPARATUS, METHOD OF CONTROLLING THE SAME, STORAGE MEDIUM, AND RENTAL SYSTEM

(71) Applicant: CANON KABUSHIKI KAISHA, Tokyo (JP)

(72) Inventor: KAZUHIRO SUGAWARA, Ibaraki (JP)

(21) Appl. No.: 18/758,588

(22) Filed: Jun. 28, 2024

(30) Foreign Application Priority Data
Jul. 4, 2023 (JP) 2023-110259

(51) Int. Cl. G06F 3/12; H04L 9/00

(52) U.S. Cl. CPC G06F 3/1239; G06F 3/1207; H04L 9/50

(57) ABSTRACT

The present disclosure directs to a printing apparatus for rental managed on a blockchain network, the printing apparatus obtaining, via a smart contract, a non-fungible token (NFT) that includes a right to print a predetermined number of sheets in the printing apparatus; enabling a print function of the printing apparatus; determining, via the smart contract, whether the number of sheets to be printed obtained from a print setting of an accepted print job is within a range of the number of printable sheets based on the obtained NFT; and in a case where the number of sheets to be printed is within the range of the number of printable sheets, executing printing in the printing apparatus, which has been rented, using the obtained NFT.

### BACKGROUND

### Field

The present disclosure relates to a printing apparatus, a method of controlling the same, a storage medium, and a rental system.

### Description of the Related Art

There are services in which printing apparatuses are rented with a limit on the number of sheets to be printed. Japanese Patent Laid-Open No. 2022-123070 proposes a technique for controlling a rental device using a non-fungible token (NFT). Specifically, by a message for device control being transmitted from an information processing apparatus to the rental device and the message being decrypted using a public key stored in an NFT, the rental device is controlled.

However, the above prior art has the following problems. In access control of a rental device using a message for device control as in the above prior art, access control at the start and end of rental is left to a user. That is, it is difficult to prevent continued use beyond limits on the rental device. For example, when a printing apparatus (MFP) is rented with a limit on the number of sheets to be printed in the MFP, even if the number of sheets printed in the MFP reaches the limit on the number of sheets, it is difficult to stop access to the MFP.

### SUMMARY OF THE INVENTION

The present disclosure enables a mechanism for suitably managing utilization of a printing apparatus on a blockchain network in a printing apparatus rental system.

One aspect of the present disclosure provides a printing apparatus for rental managed on a blockchain network, the printing apparatus comprising: one or more memory devices that store a set of instructions; and one or more processors that execute the set of instructions to: obtain, via a smart contract, a non-fungible token (NFT) that includes a right to print a predetermined number of sheets in the printing apparatus; enable a print function of the printing apparatus; determine, via the smart contract, whether the number of sheets to be printed obtained from a print setting of an accepted print job is within a range of the number of printable sheets based on the obtained NFT; and in a case where the number of sheets to be printed is within the range of the number of printable sheets, execute printing in the printing apparatus, which has been rented, using the obtained NFT.

Another aspect of the present disclosure provides a method of controlling a printing apparatus for rental managed on a blockchain network, the method comprising: obtaining, via a smart contract, a non-fungible token (NFT) that includes a right to print a predetermined number of sheets in the printing apparatus; enabling a print function of the printing apparatus; determining, via the smart contract, whether the number of sheets to be printed obtained from a print setting of an accepted print job is within a range of the number of printable sheets based on the obtained NFT; and in a case where the number of sheets to be printed is within the range of the number of printable sheets, executing printing in the printing apparatus, which has been rented, using the obtained NFT.

Still another aspect of the present disclosure provides a non-transitory computer-readable storage medium storing a computer program for causing a computer to execute each step of a method of controlling a printing apparatus for rental managed on a blockchain network, the method comprising: obtaining, via a smart contract, a non-fungible token (NFT) that includes a right to print a predetermined number of sheets in the printing apparatus; enabling a print function of the printing apparatus; determining, via the smart contract, whether the number of sheets to be printed obtained from a print setting of an accepted print job is within a range of the number of printable sheets based on the obtained NFT; and in a case where the number of sheets to be printed is within the range of the number of printable sheets, executing printing in the printing apparatus, which has been rented, using the obtained NFT.

Yet still another aspect of the present disclosure provides a rental system operable to provide a printing apparatus for rental to be managed on a blockchain network, the rental system comprising: one or more memory devices that store a set of instructions; and one or more processors that execute the set of instructions to: issue, via a smart contract, a non-fungible token (NFT) that includes a right to print a predetermined number of sheets in the printing apparatus; obtain the issued NFT via the smart contract; enable a print function of the printing apparatus; determine, via the smart contract, whether the number of sheets to be printed obtained from a print setting of an accepted print job is within a range of the number of printable sheets based on the obtained NFT; and in a case where the number of sheets to be printed is within the range of the number of printable sheets, execute printing in the printing apparatus, which has been rented, using the obtained NFT.

Further features of the present disclosure will become apparent from the following description of exemplary embodiments (with reference to the attached drawings).

### BRIEF DESCRIPTION OF THE DRAWINGS

FIG. 1 is a diagram illustrating a configuration of a system.

FIG. 2 is an example 1 of display of screens of a rental MFP.

FIG. 3 is an example 2 of display of screens of the rental MFP.

FIG. 4 is a block diagram of the MFP.

FIG. 5 is a flowchart related to print processing in the MFP.

FIG. 6 is a flowchart related to change of an owner of an NFT in the MFP.

FIG. 7 is a flowchart related to additional purchase of an NFT in the MFP.

FIG. 8 is a diagram for explaining processing of a smart contract.

FIG. 9 is a flowchart related to NFT issuance processing of the smart contract.

FIG. 10 is a flowchart related to NFT purchase/owner change processing of the smart contract.

FIG. 11 is a flowchart related to NFT print count notification processing of the smart contract.

FIG. 12 is a sequence diagram of a rental company, an information processing apparatus, the MFP, and the smart contract.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

### <Configuration of System>

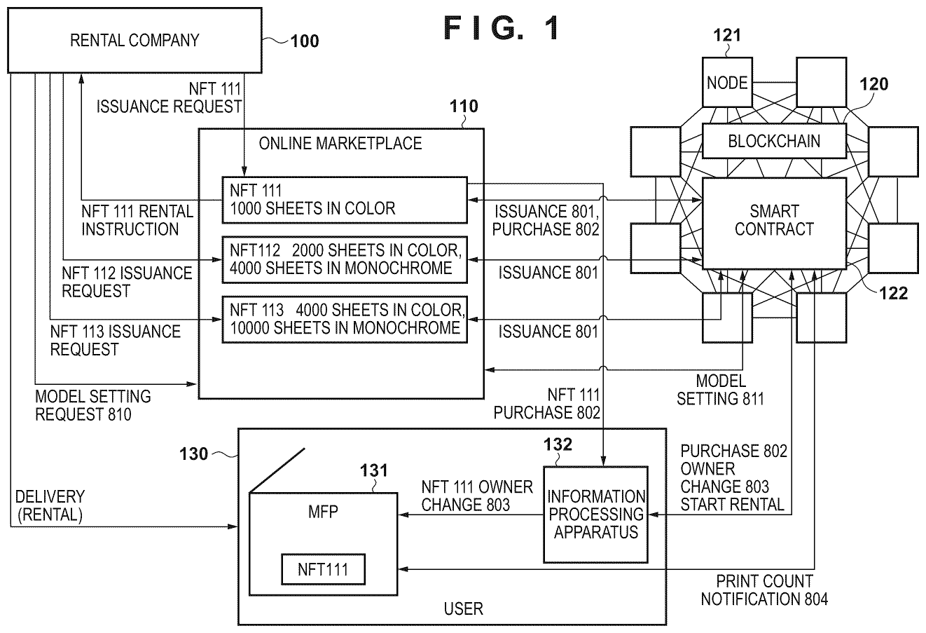

An embodiment of the present disclosure will be described below. First, an example of a configuration of a rental system according to the present embodiment will be described with reference to FIG. 1. The rental system provides rental of a printing apparatus that is managed on a blockchain network. The rental system is configured to include a rental company 100 which sells and manages devices, a printing apparatus (multi-function printer (MFP)) 131 which is a rental device, and a blockchain 120. The rental company 100 includes an information processing apparatus, and the information processing apparatus realizes processing and control to be performed by the rental company 100, which will be described below.

An online marketplace 110 is a website that sells non-fungible tokens (NFTs), which are non-fungible tokens containing MFP rental information, and is provided by the rental company 100. The online marketplace 110 is provided by an information processing apparatus, such as a server apparatus. The information processing apparatus of the rental company 100 and the information processing apparatus that provides the online marketplace 110 may be provided in an integrated manner. The online marketplace 110 is constituted by a frontend web service that performs instructions for issuance and purchase of an NFT, setting of a rentable MFP model, and the like, and a backend that transmits a transaction block to the blockchain 120.

The blockchain 120 is a system constituted by peer-to-peer (P2P) communication between a plurality of information communication apparatuses, which are arranged as nodes 121, and is also called a distributed ledger. Further, the blockchain 120 uses a blockchain technology in which a history of a plurality of pieces of transaction data in blocks (transaction blocks) is shared in a chain structure. The transaction blocks that have been recorded in the blockchain 120 are characterized in that they are immutable, there is no loss, and owners can be reliably identified. An overview of operations performed by the system will be described below.

### (Issuance of NFT)

The online marketplace 110 includes an NFT issuance web service, and an NFT name (e.g., NFT 111), the number of printable sheets (e.g., 1000 sheets in color), model information of an MFP to be rented (e.g., MFP 131), and the like can be inputted. The NFT name is a name of an NFT displayed on the online marketplace 110. The number of printable sheets indicates a setting for the number of sheets (predetermined number of sheets) that can be printed by an MFP to be rented, and rental of an MFP ends when an MFP being rented reaches the number of printable sheets. That is, in an NFT, a right to print a predetermined number of sheets in an MFP is set. Model information of the MFP 131 includes a model name of the MFP 131, a print capability (color or monochrome), and the like.

The NFT issuance web service uses a wallet of the rental company 100 and accepts an issuance request for the NFT 111 based on inputted information. The wallet is a wallet that can be used on the blockchain 120 and is used as a tool for transmitting a transaction block to the blockchain 120, storing an NFT and a virtual currency to be used at the time of sales and purchase, and displaying an NFT that has been issued and is owned. Upon accepting the issuance request for the NFT 111, the NFT issuance web service transmits a transaction block, which is an issuance 801, to a smart contract 122.

Upon receiving the issuance 801, the smart contract 122 generates a block for the NFT 111, adds it to the blockchain 120, and returns an issuance successful response (step S912) to the online marketplace 110. A wallet address of the rental company 100 is set for an owner of the NFT 111 which has just been issued.

Regarding owner information, the “wallet address of the rental company 100” will be abbreviated to the “rental company 100” in the following. The issued NFT 111 is displayed as an NFT for sale on the online marketplace 110. Further, the rental company 100 issues an NFT 112 (set to 2000 sheets in color and 4000 sheets in monochrome) and an NFT 113 (4000 sheets in color and 10000 sheets in monochrome) in a manner similar to the NFT 111 and sells them on the online marketplace 110. As described above, by preparing an MFP to be rented and an NFT in which the number of sheets (predetermined number of sheets) that can be printed in an MFP has been set, the rental company 100 can provide a rental service for which various conditions have been set.

### (Setting of Rentable Model)

The rental company 100 makes a model setting request 810 to the online marketplace 110 for an inventory status of a rental MFP, addition of a rental MFP model, and the like. A model name of a rental MFP, the number of rentable units, a maximum value for the number of printable sheets, units (1000 sheets) for a setting for the number of printable sheets, and the like can be designated in the model setting request 810. The online marketplace 110 sets rentable model information of the smart contract 122 by transmitting a transaction block, which is a model setting 811, to the smart contract 122. When an inventory of a rental MFP reaches 0, rentable model information can be deleted from the smart contract 122 using the transaction block, which is the model setting 811. Then, an NFT related to that rentable MFP is set to be not for sale from the online marketplace 110. Further, when adding a new model, the rental company 100 makes a setting request for adding a model to the smart contract 122 using the model setting 811 and adds a new rental MFP to rentable models of the smart contract.

### (Purchase of NFT)

When purchasing the NFT 111, a user 130 purchases the NFT 111 from the online marketplace 110 using a wallet of an information processing apparatus 132 that they own. The information processing apparatus 132 accesses the NFT purchase web service of the online marketplace 110 and sets a transmission destination of the user 130, which is a rental destination, and a wallet address of the user 130. The online marketplace 110 stores information inputted as metadata of the NFT 111 in an IPFS (distributed file system) to be referenced from a URI of the NFT. After storing the input information, the online marketplace 110 generates a block, which is a purchase 802, and transmits the block to the smart contract 122. The smart contract 122 changes owner information of the NFT 111 to the user 130 and transmits that owner change for the NFT 111 has been successful to the online marketplace 110 as a response to the purchase 802. After receiving the response that the owner change for the NFT 111 has been successful, the online marketplace 110 transmits to the rental company 100 an instruction for lending the MFP 131 (including an address of the user 130) and delivers the MFP 131 to a delivery destination (address of the user 130) based on the input information. Further, the online marketplace 110 sets the NFT 111 to be not for sale (not displayed) on the online marketplace 110.

### (Start Rental of MFP)

After the purchase of the NFT 111, when the MFP 131 is delivered to the transmission destination of the user 130, the owner is changed from the user 130 that purchased the NFT 111 to the MFP 131. In response to an instruction by the user 130, a transaction block (owner change 803) for owner change of the NFT 111 is transmitted to the smart contract 122 using the wallet of the information processing apparatus 132. After receiving the owner change 803, the smart contract 122 performs confirmation for change of the owner information of the NFT 111 to the MFP 131, generates a post-owner-change block 823, and adds the block 823 to the blockchain 120. When generating the block 823, the smart contract 122 stores a date on which the owner of the NFT 111 has been changed to the MFP 131 in the block 823 as a date on which rental of the MFP 131 has been started. The rental company 100 can confirm a date on which the user 130 started using the MFP 131 by confirming the block generated by the smart contract 122.

### (Notification of Number of Printed Sheets)

When rental of the MFP 131 is started by the owner change of the NFT 111, the MFP 131 enables a print function. Further, at the time of execution of the print function, the MFP 131 transmits a print count notification to the smart contract 122. When the number of sheets printed using the print function reaches the number of printable sheets of the NFT 111, the MFP 131 disables the print function (stops the function), assuming that the number of printable sheets is 0.

The above is the overview of the rental system in which an NFT is used. As described above, in the present disclosure, it is possible to construct a system that manages the number of printed sheets of the rented MFP 131 using the NFT 111 and the smart contract 122, where the print function of the MFP 131 can be used for the number of printable sheets at the time of purchase of the NFT. Further, by having an NFT issued, the rental company 100 can manage, on a blockchain network, a series of operations from the start of rental to monitoring of the number of printed sheets of a user and the end of rental. A configuration may be taken so as to rent the MFP 131 without purchase of an NFT, purchase an NFT in the MFP 131, and start rental using the NFT purchased in the MFP 131. Further, in a case where a rental contract has been concluded, it is possible to use an NFT sold in a secondary market. Also in that case, rental starts when the owner of the NFT is changed to the MFP 131, and the MFP 131 can be used for the number of printable sheets of the purchased NFT. As described above, in the present disclosure, by using an NFT and the smart contract, various usage patterns can be realized. The present disclosure can utilize the characteristics of a blockchain and provide a rental system that is immutable, facilitates confirmation of a history (traceable), and ensures guarantee of authenticity (identification of owner).

### <Screen Transition of MFP>

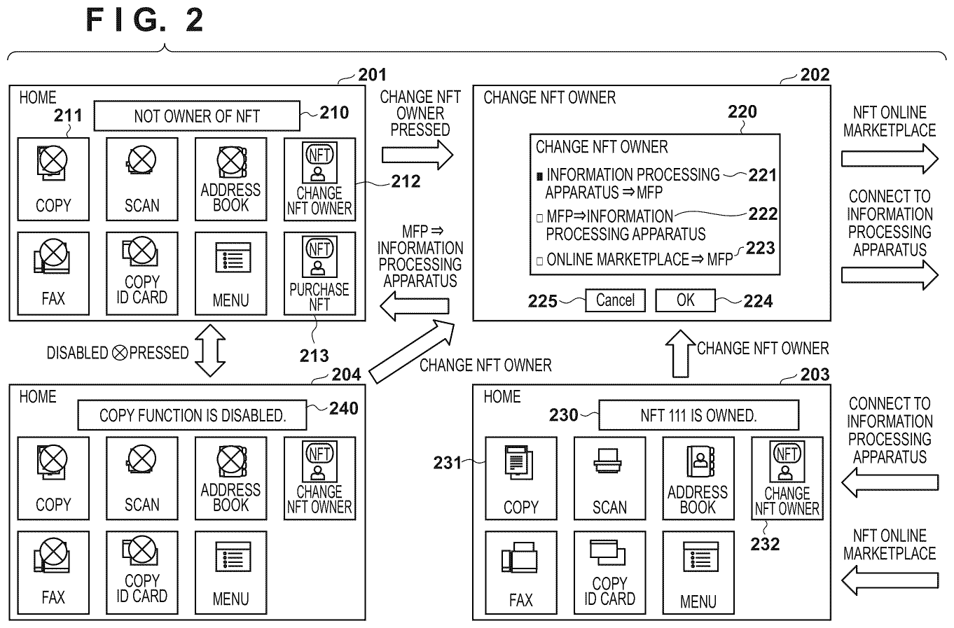

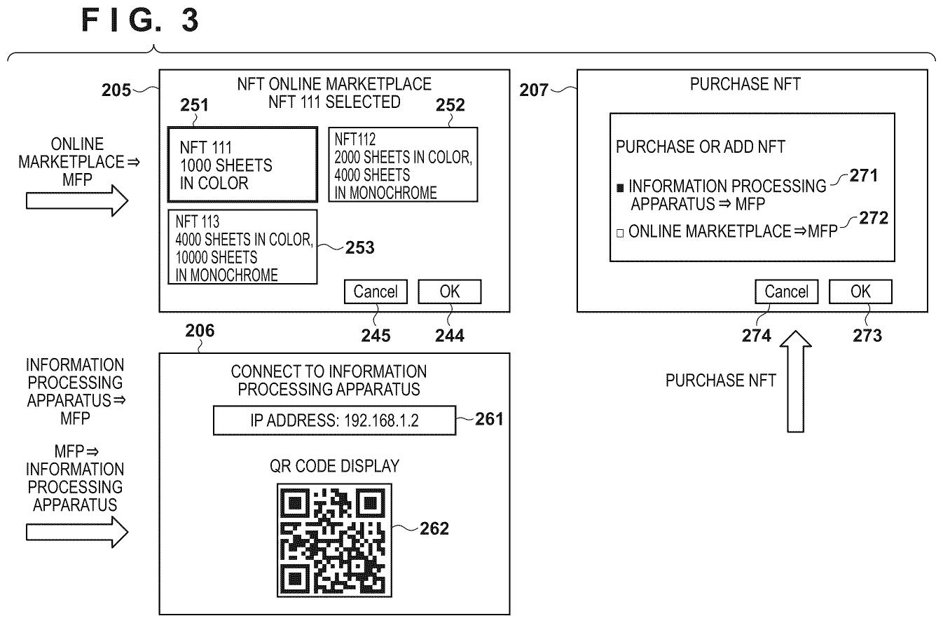

Transition of display screens to be displayed on an operation panel 409 of the MFP 131 according to the present embodiment will be described below with reference to FIGS. 2 and 3. First, display screens of FIG. 2 will be described.

A home screen 201 indicates a home screen to be displayed on the operation panel 409 when the MFP 131 delivered from the rental company 100 is activated for the first time. When the MFP 131 is activated for the first time, the owner of the NFT 111 is not the MFP 131, and so, the home screen 201 is displayed so as to include a message, “not owner of NFT” (no NFT display 210). Further, regarding each function button, a display indicating that the function is disabled (e.g., copy 211) is displayed. When a button, copy 211, is operated in this state, a home screen 204 is transitioned to, and a message, “Copy function is disabled.” (copy function disabled 240), is displayed.

When change NFT owner 212 of the home screen 201 is operated, an NFT owner change screen 202 is transitioned to. In the NFT owner change screen 202, a transmission source and a transmission destination for the owner of an NFT are designated in a setting region, change NFT owner 220, and the owner of the NFT can be changed. Regarding this operation, an NFT owner change operation (not illustrated) may be executed from the wallet on the information processing apparatus 132. A button, purchase NFT 213, on the home screen 201 is a button for purchasing a new NFT to add the number of printable sheets, such as when the number of printable sheets is insufficient. When purchase NFT 213 is operated, an NFT purchase screen 207 is transitioned to.

When changing the owner of an NFT from the user 130 to the MFP 131, a checkbox 221 of change NFT owner 220 is designated. When changing the owner of an NFT from the MFP 131 to the user 130, a checkbox 222 of change NFT owner 220 is designated. When purchasing an NFT from the online marketplace 110 and changing the owner to the MFP 131, a checkbox 223 of change NFT owner 220 is designated. After a respective checkbox is designated, a next screen can be transitioned to by operation of a button, OK 224. When the button, OK 224, is operated after the checkbox 221 or 222 has been designated, a screen 206 for connecting with an information processing apparatus is transitioned to. When the button, OK 224, is operated after the checkbox 223 has been designated, an NFT online marketplace screen 205 is transitioned to. Meanwhile, when a button, Cancel 225, is operated, a screen before transition was made to change NFT owner is returned to. The screens 205 and 206 will be described later with reference to FIG. 3.

When a connection with the information processing apparatus 132 is established in the screen 206 and the owner of the NFT 111 is changed to the MFP 131, a home screen 203 is transitioned to, and a message 230, “NFT 111 is owned”, is included. The respective function buttons of the home screen 203 are different from those of the home screen 201, and a disabled display of copy 211, for example, is switched to an enabled display (x not illustrated) of copy 231, and transition can be made to operation screens (not illustrated) of respective functions. That is, each function button is displayed so as to be selectable. When a change NFT owner button 232 is operated while an NFT is owned, the NFT owner change screen 202 is transitioned to. It is possible to sell the NFT 111 on the online marketplace 110 from the MFP 131, transfer the NFT to another MFP, and return the ownership of the NFT to the information processing apparatus. It is a useful function for when rental has ended, when an NFT has been additionally purchased but not used, and the like.

Next, display screens of FIG. 3 will be described. The NFT online marketplace screen 205 is a screen in which the online marketplace 110 is displayed by the MFP 131. NFTs for sale on the online marketplace 110 are displayed, and by displaying NFTs that do not fit in the screen by switching by scrolling or the like, it is possible to display all NFTs on the online marketplace 110. Regarding NFTs to be displayed, configuration may be taken such that, by the model information of the MFP 131 being obtained, only NFTs that can be used in the MFP 131 among NFTs for sale are displayed.

The online marketplace screen 205 displays the NFTs 111 to 113 for sale on the online marketplace 110, and it is possible select an NFT by operating respective buttons 251 to 253 and, by operating a button, OK 244, purchase the NFT on the NET online marketplace 110. In this case, it is necessary to transmit a transaction block for transferring payment in advance to the wallet of the MFP 131 from the information processing apparatus 132. When the NFT 111 has been purchased, the owner of the NFT 111 is set to the MFP 131, and the home screen 203 illustrated in FIG. 2 is transitioned to. A button, Cancel 245, returns to the NFT owner change screen 202 before transition was made to the NFT online marketplace screen 205.

Regarding the screen 206, a connection with the information processing apparatus 132, which purchased the NFT 111, is established, the wallet information of the MFP 131 is obtained, and the owner of the NFT 111 is changed by transmitting the owner change 803 for the NFT from the information processing apparatus 132 to the smart contract 122. When the owner of the NFT 111 is changed to the MFP 131, the home screen 203 illustrated in FIG. 2 is transitioned to. The screen 206 displays an IP address input 261 for connecting with the information processing apparatus 132 and a QR code 262, and a connection with the information processing apparatus 132 is established after input. By the QR code being imaged by the information processing apparatus 132, network connection processing is automatically executed from the information processing apparatus. Regarding the IP address input 261, communication is performed from the MFP 131 to the information processing apparatus 132, information for changing the owner of the NFT is obtained, and the owner of the NFT 111 is changed.

The NFT purchase screen 207 is a screen for the user 130 to purchase or add an NFT. A checkbox 271, which is from the information processing apparatus to the MFP, is a checkbox for allowing the information processing apparatus 132 to use a purchased NFT in the MFP 131. By operating an OK button 273, it is possible to change the owner of the NFT to the MFP 131 and add the number of printable sheets according to the NFT for which the owner has been changed. Further, when adding an NFT directly to the MFP 131 from the online marketplace 110, by checking a checkbox 272 and operating the OK button 273, the NFT online marketplace screen 205 is transitioned to.

As described with reference to FIGS. 2 and 3, it is possible to set the owner of the NFT 111 to the MFP 131 from the NFT owner change screen 202 in the MFP 131 distributed for rental. By owning the NFT 111, it is possible for the MFP 131 to execute functions, such as copy, scan, address book, fax, and ID card copy. Further, by changing the owner of the NFT in a state in which the functions are enabled, it is possible to transition to the home screen 201 in which the function are disabled.

### <Hardware Configuration of MFP>

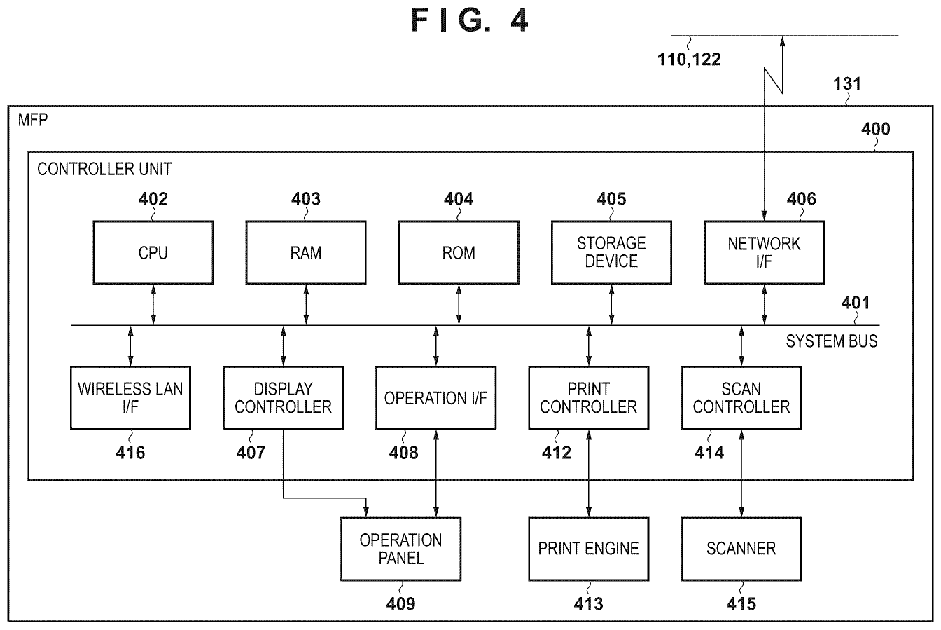

Next, a hardware configuration of the MFP according to the present embodiment will be described with reference to FIG. 4. The MFP 131 includes a controller unit 400, the operation panel 409, a print engine 413, and a scanner. The controller unit 400 includes a CPU 402, a RAM 403, a ROM 404, a storage device 405, a network I/F 406, a wireless LAN I/F 416, and an operation I/F 408. The controller unit 400 includes a display controller 407, a print controller 412, and a scan controller 414.

Regarding the controller unit 400, the CPU 402, the RAM 403, the ROM 404, and the storage device 405 are connected directly to a system bus 401. The controller unit 400 is connected to external devices by the network I/F 406, the display controller 407, the operation I/F 408, the print controller 412, and the scan controller 414. These components are connected to the system bus 401 and are capable of communicating with each other.

The CPU 402 is a central processing unit that controls the entire operation of the controller unit 400. The RAM 403 is a volatile memory. The ROM 404 is a non-volatile memory and stores a startup program for the CPU 402. The storage device 405 is a storage device (e.g., hard disk drive (HDD)) with a larger capacity compared to the RAM 403. The storage device 405 stores an MFP control program to be executed by the CPU 402. The storage device 405 may be replaced by another storage device that has similar functions to a hard disk drive, such as a solid state drive (SSD). Further, the storage device 405 stores the wallet of the MFP 131 for accessing the blockchain 120, and information on an address on the blockchain 120, a token amount (virtual currency), a private key, a public key, and NFT information are held. The NFT information includes a name, an NFT token (contract address and token ID), a token URI, an NFT description, and the like of an NFT owned by the MFP 131.

When the MFP 131 is powered on, the CPU 402 executes a startup program stored in the ROM 404. The startup program is for reading out a control program stored in the storage device 405 and deploying it on the RAM 403. Upon executing the startup program, the CPU 402 then executes the control program deployed on the RAM 403 and performs control. Further, the CPU 402 stores data to be used at the time of execution of the control program on the RAM 403 and reads from and writes to it. The storage device 405 can further store various settings necessary for when the control program is executed and image data read by a scanner 415, and reading and writing are performed by the CPU 402. The CPU 402 communicates with other devices on the network via the network I/F 406 and the online marketplace 110 on the Internet via a gateway. To enable the MFP 131 to access the blockchain 120, a transaction block, such as the purchase 802 and the owner change 803, is generated for the smart contract 122 and an RPC in the control program of the MFP 131 is implemented. RPC is an abbreviation for remote procedure call.

The display controller 407 performs screen display control of a touch panel on the connected operation panel 409 in response to instructions from the CPU 402. The operation I/F 408 performs input and output of signals related to operations performed on the operation panel 409. The operation I/F 408 is connected to the operation panel 409, and when the touch panel is operated, the CPU 402 can obtain coordinates of the touch panel on which an operation has been performed via the operation I/F 408.

The print controller 412 transmits a control command and image data to the connected print engine 413 in response to an instruction from the CPU 402. The print engine 413 prints received image data on a sheet according to a control command received from the print controller 412. A detailed description of the print engine 413 is not the spirit of the present embodiment, and so, further description will be omitted.

The scan controller 414 transmits a control command to the connected scanner 415 in response to an instruction from the CPU 402 and writes image data received from the scanner 415 in the RAM 403. The scanner 415 reads a document on a glass document table (not illustrated) provided in the printing apparatus 131 or a document placed on an ADF using an optical unit according to a control command received from the scan controller 414. The document read by the scanner 415 is stored in the RAM 403 as image data, and the image data is converted to a PDF/JPEG/TIFF file format by the CPU 402 according to a setting for a file format and is stored in the storage device 405.

### <Print Processing Procedure>

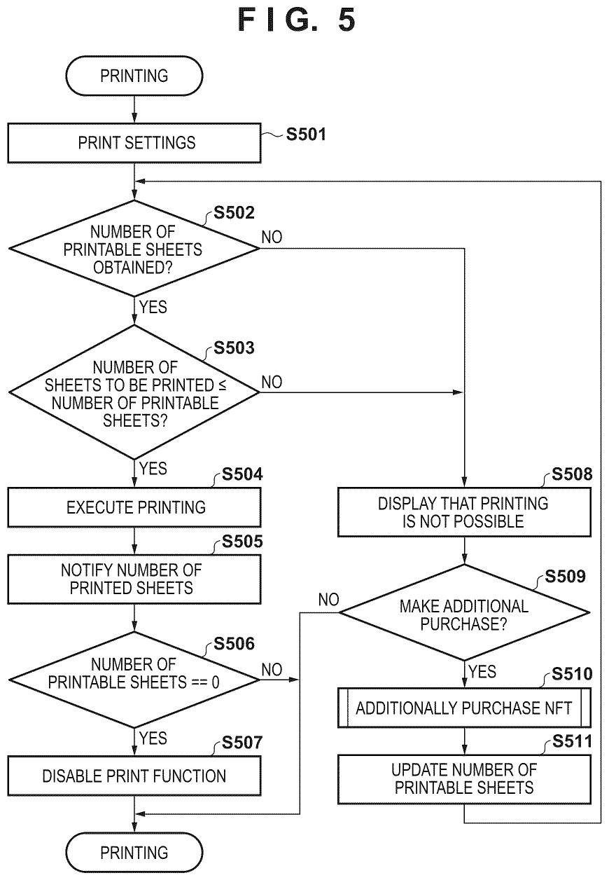

Next, a processing procedure of print processing in the MFP 131 in which the print function has been enabled according to the NFT 111 according to the present embodiment will be described with reference to FIG. 5. Regarding the MFP 131, print functions are executed by the CPU 402 controlling the operation panel 409 and the print engine 413. The processing to be described below is realized, for example, by a program stored in the ROM 404 or the storage device 405 being read out to the RAM 403 and executed by the CPU 402.

In step S501, the CPU 402 displays a print setting screen (not illustrated) on the operation panel 409 and receives input related to print settings (number of sheets to be printed, color, monochrome, the number of copies, and other numerical values), as a print job. When copying, the CPU 402 obtains the number of sheets to be printed by performing scanning in advance. When receiving print data from the outside and printing the print data, the CPU 402 obtains the number of sheets to be printed from the number of pages of images stored in the RAM 403. Regarding an initial number of printable sheets, the number of printable sheets of the NFT 111 is obtained by inquiring the smart contract 122 when the owner of the NFT 111 is changed to the MFP 131. The number of printable sheets of an NFT is set by the rental company 100 at the time of issuance of the NFT and is held as a status variable of the smart contract 122 for each NFT.

In step S502, the CPU 402 determines whether the number of printable sheets has been obtained from the smart contract 122. If it has been obtained, the processing transitions to step S503, and if could not be obtained, the processing proceeds to step S508. In step S503, the CPU 402 compares the number of sheets to be printed obtained in step S501 with the number of printable sheets of the NFT 111 and determines whether the number of sheets to be printed is within a range of the number of printable sheets. If the number of sheets to be printed is greater than the number of printable sheets, it is determined that printing cannot be executed, and the processing transitions to step S508. Meanwhile, if the number of sheets to be printed obtained in step S501 is less than or equal to the number of printable sheets of the NFT 111, it is determined that printing can be executed, and the processing transitions to step S504.

In step S504, the CPU 402 performs printing according to the print settings of step S501. Next, in step S505, the CPU 402 transmits a print result including the number of printed sheets to the smart contract 122 using a print count notification 804. After transmitting the print count notification 804, the CPU 402 obtains an updated number of printable sheets by receiving a response for the print count notification 804 from the smart contract 122. In step S506, the CPU 402 determines whether the number of printable sheets has reached 0, and if it is not 0, the processing of this flowchart is ended. Meanwhile, if the number of printable sheets has reached 0, the processing transitions to step S507. In step S507, after confirming that the number of printable sheets of the NFT 111 has reached 0, the CPU 402 disables the print function, displays the home screen 201, and terminates the processing of this flowchart.

Meanwhile, in step S508, the CPU 402 displays on the operation panel 409 that printing for which settings have been made in step S501 cannot be executed due to the number of printable sheets being insufficient. That display screen is displayed so as to include an object for instructing additional purchase of an NFT. Next, in step S509, the CPU 402 determines whether to additionally purchase an NFT to increase the number of printable sheets. In a case of making an additional purchase, the processing transitions to step S510, and in a case of not making an additional purchase, the processing of this flowchart is terminated. In step S510, the CPU 402 displays the NFT online marketplace screen 205 and accepts additional purchase of an NFT. When an additional purchase has been made, in step S511 the CPU 402 obtains the number of printable sheets from the additionally-purchased NFT, updates the number of printable sheets, and returns the processing to step S502.

By executing the print processing described above, it is possible to manage the print function of the MFP 131 while monitoring the number of sheets to be printed using the NFT 111. Further, by allowing additional purchase of an NFT when the number of printable sheets reaches 0, even if it is not possible to predict in advance that the number of printable sheets will be close to 0, it is possible to re-enable the print function by additional purchase of an NFT. Further, by preparing two types (color printing and monochrome printing) of number of printable sheets, it is possible to, if the number of printable sheets reaches 0 only for color printing and the number of printable sheets for monochrome printing has not reached 0, disable only a print function for color and allow use of a print function for monochrome.

### <Change Owner of NFT>

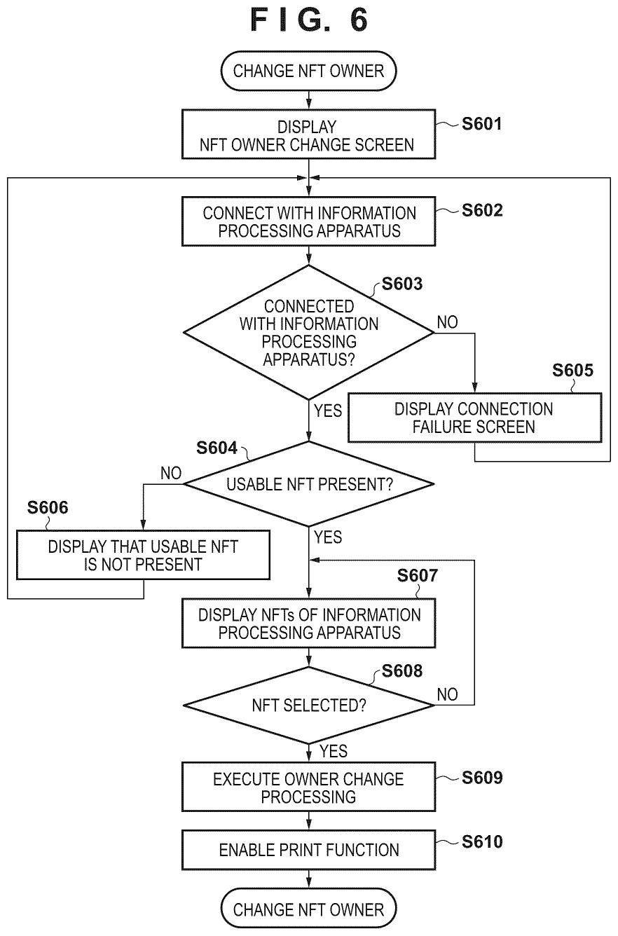

Next, a processing sequence for changing the owner of an NFT in the MFP 131 according to the present embodiment will be described with reference to FIG. 6. The processing to be described below is realized, for example, by a program stored in the ROM 404 or the storage device 405 being read out to the RAM 403 and executed by the CPU 402.

In step S601, the CPU 402 displays the NFT owner change screen 202 on the operation panel 409 and accepts an operation. If operation of OK 224 is accepted in a state in which the checkbox 221 or 222 is checked, the processing proceeds to step S602. In step S602, the CPU 402 displays the screen 206 on the operation panel 409, accepts a setting for connecting with the information processing apparatus 132, and establishes a connection.

In step S603, the CPU 402 determines whether the information processing apparatus 132 is connected; if connected, the processing transitions to step S604, and if not connected, the processing transitions to step S605. In step S605, the CPU 402 displays on the screen 206 that connection with the information processing apparatus has failed and returns the processing to step S602.

In step S604, the CPU 402 obtains the wallet information of the information processing apparatus 132 and determines an NFT that can be used in the MFP 131 from the model information and the number of printable sheets. If a usable NFT is owned, the processing transition to step S607, and if not owned, the processing transitions to step S606. In step S606, the CPU 402 displays on the screen 206 that a usable NFT is not present in the information processing apparatus 132 and returns the processing to step S602.

In step S607, the CPU 402 displays NFTs in the information processing apparatus 132 and receives selection of an NFT. In step S608, the CPU 402 determines whether selection of an NFT has been detected. If selection of an NFT has been detected, the processing transitions to step S609, and if selection of an NFT has not been detected, the processing returns to step S607.

In step S609, the CPU 402 obtains information of the selected NFT from the information processing apparatus 132 and executes owner change processing. Next, in step S610, the CPU 402 enables the print function, allows display of the home screen 203 in which each function is executable, and terminates the processing of this flowchart. If the functions are already enabled in step S610, the CPU 402 skips enabling processing.

Here, a processing procedure for changing the owner of an NFT to the MFP 131 has been described. However, the processing procedure described above is an example of a method of changing the owner and is not intended to limit the present disclosure. For example, a configuration may be taken so as to embed content of processing to be executed in a QR code so as to be executed automatically without user operation. Further, as in the present embodiment, it is possible to set a date and time at which the user 130 shifted the owner of an NFT from the wallet of the information processing apparatus 132 to the wallet of the MFP 131 as the start of rental of the MFP 131. Further, control may be performed so as to start rental with a trial period added to a timing at which the owner of an NFT has been changed. Further, by changing the owner of an NFT during a trial period and returning the MFP 131 to the rental company 100, it is possible to suspend rental during the trial period. These processes can be realized simply by being added to the smart contract 122.

### <Additional Purchase of NFT>

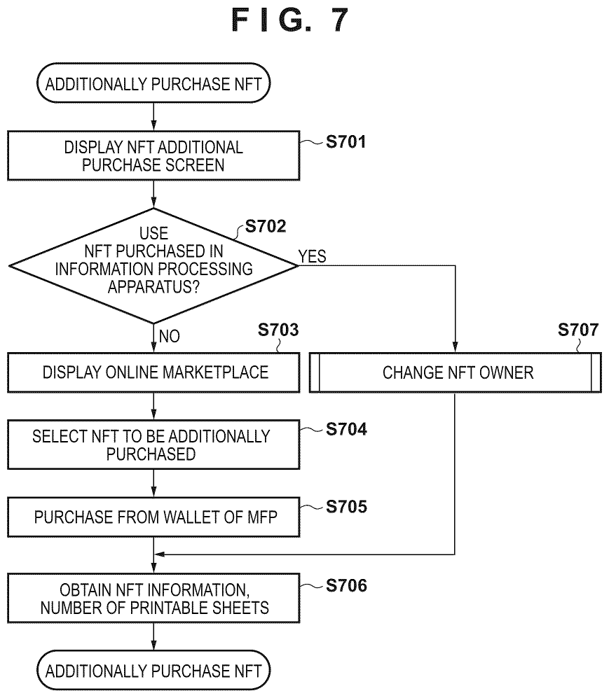

Next, a processing procedure at the time of additional purchase of an NFT of step S509 above will be described with reference to FIG. 7. An example in which an additional purchase is made after printing becomes unavailable will be described but is not intended to limit the present disclosure, and control may be performed so as to make an additional purchase after the number of printable sheets becomes small. In that case, an additionally purchase NFT button may be provided, and a purchase may be made from display of the NFT online marketplace screen 205. Further, by changing the owner of an NFT that has already been purchased in the information processing apparatus 132, the additionally-purchased NFT may be made usable in the MFP 131. The processing to be described below is realized, for example, by a program stored in the ROM 404 or the storage device 405 being read out to the RAM 403 and executed by the CPU 402.

In step S701, the CPU 402 displays the NFT additional purchase screen 207. In step S702, the CPU 402 determines whether to add an NFT purchased in the information processing apparatus 132. In the case of adding an NFT purchased in the information processing apparatus 132, the processing transitions to step S707, and in the case of making a purchase from an online marketplace, the processing transitions to step S703. In step S707, the CPU 402 receives change of the owner of the NFT from the information processing apparatus 132 to the MFP 131 via the screen 202, executes it, and transitions to step S706.

In step S703, the CPU 402 displays the NFT online marketplace screen 205 and allows selection of an NFT of the online marketplace 110. Next, in step S704, upon detecting that an NFT has been selected, the CPU 402 determines an NFT to be purchased. Further, in step S705, the CPU 402 transmits a block, which is the purchase 802, to the smart contract 122 using the wallet of the MFP, purchases the NFT, and transitions to step S706.

In step S706, the CPU 402 obtains NFT information of the purchased NFT and adds the number of printable sheets of the NFT. The smart contract 122 subtracts the number of printed sheets from the number of printable sheets for each NFT, and so, the MFP 131 notifies the smart contract 122 of the number of sheets before 0 is reached (remaining number of the current NFT) and, regarding the number of sheets to be printed next, switches over to the additionally-purchased NFT and processes a print count notification.

Additional purchase of an NFT has been described above. By constructing such an MFP rental system that collaborates with an NFT, when renting an MFP with the number of printable sheets, it is possible to start the rental with a contract in which the number of sheets to be printed is small and increase or decrease the number of printable sheets according to an actual usage state. Further, in the case of concluding a contract under a rental condition that three purchases are to be made each month, it is possible to realize processing that complies with the condition of the contract using the smart contract 122.

### <Smart Contract>

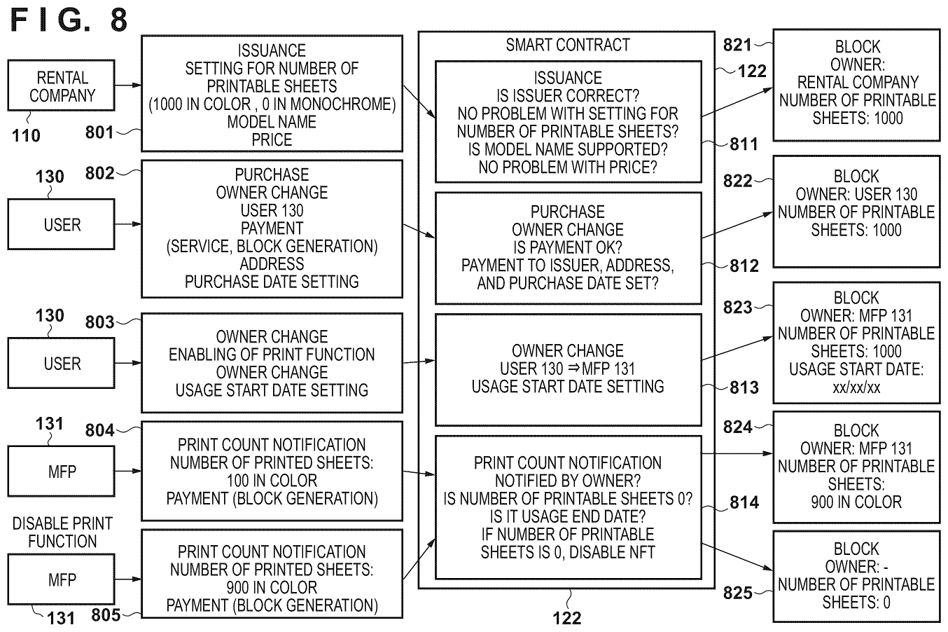

Next, content of processing of the smart contract according to the present embodiment will be described with reference to FIG. 8. The smart contract is one of the blocks arranged in the blockchain 120 and is written onto the blockchain similarly to other blocks, thereby becoming a block that is shared between nodes. The smart contract is different from a transaction block in that it is a block in which processing can be written and it can write an execution command in a received transaction block and store a block that has been generated from an execution result on the blockchain. FIG. 8 illustrates, for transaction blocks 801 to 805 received by the smart contract, processing in the smart contract in central blocks 811 to 814 and blocks 821 to 825 outputted as processing results in blocks on the right. The rental company 100, the user 130, and the MFP 131 indicate sources from which transmission of a transaction block to the smart contract 122 is instructed.

The issuance 801 is a transaction block for issuing an NFT using the wallet of the rental company 100. The rental company 100 sets the number of printable sheets (1000 sheets in color and 0 sheets in monochrome), the model name of the MFP 131, and an NFT price as information for issuing an NFT and transmits the issuance 801 to the smart contract 122. Although only settings related to the present disclosure are illustrated, in order to issue an NFT, an NFT name, description, a token ID, a symbol, a token URI, the total number issued, the number issued initially, tradability, and the like may be additionally designated.

An issuance 811 indicates NFT issuance processing of the smart contract 122 for when the issuance 801 is received. In the NFT issuance processing, the issuance 811 generates a block 821 and adds the generated block 821 to the blockchain 120. The main processing of the issuance 811 is to confirm, based on block information of the issuance 801, whether the issuer is the rental company 100, whether the number of sheets can be set based on a setting for the number of printable sheets and the model name of the MFP, and whether there is any problem with the price setting. The block 821 indicates a block to be referenced by a generated NFT, and the rental company 100 is set as the owner information, 1000 sheets is set for the number of printable sheets as a state variable, and a token URI (model information) and the like are set. Regarding the NFT, changes of the owner, state variables, and the like are stored as blocks on the blockchain network, with the block 821, which has been generated at the time of issuance, as a starting point, and so, it is possible to track the history of changes of the issued NFT.

The purchase 802 is a transaction block for purchasing the issued NFT using the wallet of the information processing apparatus 132 of the user 130. Regarding the purchase 802, change of the owner to the user 130 that purchased the NFT, payment information, an address, and a date of purchase are set. A purchase 812 indicates NFT purchase processing of the smart contract 122 for when the purchase 802 is received. In the NFT purchase processing, the owner of the NFT is changed to the wallet address of the user 130, payment is made to the rental company 100, the address of the user 130 is confirmed, a purchase date is stored, and a block 822 in which a result of the NFT purchase processing is stored is generated. The block 822 is a block generated in the processing of the purchase 812, the owner is changed to the user 130, and the number of printable sheets is set to 1000 sheets in color. When the block 822 is added to the blockchain 120 after being generated, an instruction to make a delivery to the address of the user 130 is notified from the smart contract 122 to the rental company 100 as a response for the purchase 802.

The owner change 803 is a transaction block for changing the owner of the NFT from the user 130 to the MFP 131. The MFP 131 enables the print function according to the number of printable sheets of the NFT, which is owned by its own wallet. An owner change 813 indicates processing for generating a block for changing the owner of the NFT using the smart contract 122. Here, a date on which owner information of the NFT has been changed from the user 130 to the MFP 131 is set as a rental start date. The block 823 is a block in which the owner of the NFT is set to the MFP 131 and a rental start date is set.

The print count notification 804 is a transaction block for notifying the smart contract 122 of the number of sheets (100) for which print processing has been performed in the MFP 131. Here, the number of printed sheets, 100 sheets, is notified. A print count notification 814 is processing for the smart contract 122 to subtract the number of printed sheets (100) from the number of printable sheets (1000) of the NFT and generate a block 824 in which a change to a new number of printable sheets (900) has been made. The block 824 is stored on the blockchain as a block in which the number of printable sheets has been updated.

The print count notification 805 is a transaction block for notifying the smart contract 122 of the number of sheets (900) for which print processing has been performed in the MFP 131. Regarding the print count notification 814, the smart contract 122 subtracts the number of printed sheets (900) from the number of printable sheets (900) of the NFT and generates a block 825 in which change to a new number of printable sheets (0) has been made. The block 825 is a block in which the number of printable sheets is 0, and when the block 825 is added to the blockchain, the print function of the MFP 131 becomes disabled due to the number of printable sheets notified as a response to the print count notification 805 being 0.

The print function of the MFP can be used up to the number of printable sheets designated in the rental of the MFP 131 based on the processes of the smart contract 122 illustrated in FIG. 8. By simply setting rental information (number of printable sheets, model name, and price) in the issuance 801, the rental company can confirm information, such as the print history of a rented MFP, a rental start date, and a rental end date, on the blockchain. Further by using the smart contract 122, the print history of the MFP 131 is stored on the blockchain network in an immutable manner (in blocks), thereby making it possible to prevent illicit use, such as manipulation of the number of sheets to be printed and extension of a rental period. Further, when the number of printable sheets is defined for color and monochrome in the issuance 801 of an NFT, if the number of printable sheets reaches 0 for both color and monochrome, both print functions are disabled, and it is possible to continue using a print function whose number of printable sheets that has not yet reached 0.

### <Smart Contract: NFT Issuance>

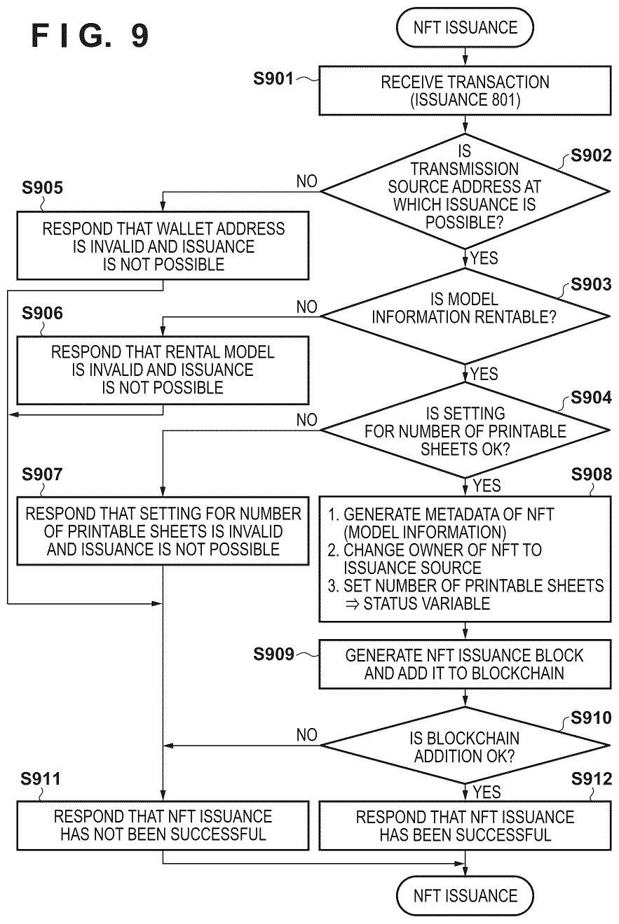

Next, a processing procedure for issuing an NFT using the smart contract 122 will be described with reference to FIG. 9. For each step, a transaction block (issuance 801) is verified by the plurality of nodes 121 on the blockchain, and issuance processing is executed.

In step S901, the smart contract 122 receives the issuance 801 and, upon receiving the issuance 801, executes transaction block verification in steps S902 to 904.

In step S902, the smart contract 122 verifies whether the transmission source is an address at which issuance of an NFT can be executed and, if it is an address at which issuance is possible, transitions to step S903 and, if it is an address at which issuance is not possible, transitions to step S905. Information of an address at which issuance is possible may be stored when the smart contract 122 is deployed on the blockchain 120 or may be stored as data that can be referenced from the smart contract 122.

In step S903, the smart contract 122 references whether a corresponding model of model information included in the issuance 801 is rentable and, if it is a rentable model, transitions to step S904 and, if it is not a rentable model, transitions to step S906. In step S904, the smart contract 122 determines whether a setting for the number of printable sheets included in the issuance 801 is normal based on a maximum number of printable sheets of the rentable model information. If it is determined that the setting for the number of printable sheets is normal, the processing transitions to step S908, and if it is determined that the setting for the number of printable sheets is invalid, the processing transitions to step S907.

In step S905, the smart contract 122 sets, as a response for the issuance 801, that a wallet address that is an issuance source is not the wallet address of the rental company 100 and transitions to step S911. Further, in step S906, the smart contract 122 sets, as a response for the issuance 801, that the setting for the rental model is invalid and transitions to step S911. Further, in step S907, the smart contract 122 sets, as a response for the issuance 801, that the setting for the number of printable sheets is invalid and transitions to step S911.

Meanwhile, in step S908, the smart contract 122 generates metadata of an NFT from the model information, sets the owner of the NFT to the wallet address of the rental company 100, and sets the number of printable sheets as a status variable, and generates the block 821. Next, in step S909, the smart contract 122 generates the block 821 for the NFT so as to include the received transaction block, which is the issuance 801, and makes a request for addition as a block on the blockchain 120. In step S910, the added block 821 is verified by each node 121 on the blockchain 120, and the smart contract 122 determines whether the block 821 is a valid block. If it is confirmed that it is a valid block, it is determined that the block 821 has been added to the blockchain 120, and the processing transitions to step S912. Meanwhile, if it is cannot be confirmed that it is a valid block, the processing transitions to step S911.

In step S911, the smart contract 122 returns a response that the issuance 801 of the NFT has not been successful to the transmission source as a response to the issuance 801 and ends the processing of this flowchart. Meanwhile, in step S912, the smart contract 122 returns a response that the issuance 801 of the NFT has been successful to the transmission source and ends the processing of this flowchart.

Upon issuing the NFT, the smart contract 122 notifies the online marketplace 110 of a token ID of the issued NFT and allows the NFT to be sold. The issued NFT can be accessed using a token ID and a transaction block hash and a transaction block ID of the block 821 and can also be accessed using the address of the smart contract 122 that issued the NFT and the token ID. Regarding the online marketplace 110, by the issued NFT being displayed on the online marketplace, it is possible for the NFT to be purchased from the information processing apparatus 132 of the user 130.

### <Smart Contract: NFT Purchase and Owner Change>

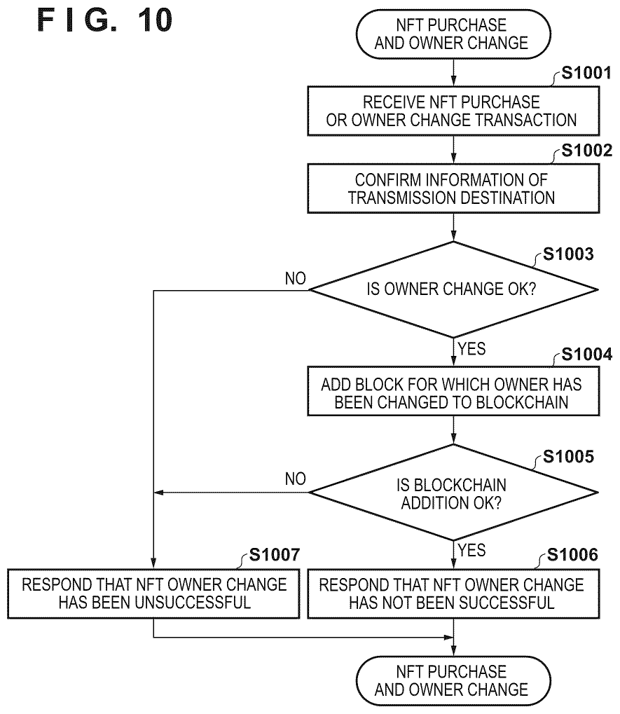

Next, a processing procedure for purchasing an NFT using the smart contract 122 will be described with reference to FIG. 10. The owner change and NFT purchase will be described using the same flowchart since similar processing is performed.

In step S1001, the smart contract 122 receives a transaction block, which is the NFT purchase 802 or the owner change 803. A difference is that, in the case of the NFT purchase 802, the sale occurs on the online marketplace 110 on which the owner and the issuer are the same, and regarding the owner change 803, the current NFT owner is simply changed to another owner, and so, both procedures will be described using this flowchart.

In step S1002, in order to confirm information of a transmission destination, the smart contract 122 confirms whether the wallet address of the transmission destination has a payment capability that allows NFT purchase or owner change. A price to be paid includes a price defined at a transmission source and a network fee for generating a block for an NFT in the smart contract 122. In the NFT purchase 802, a transmission destination of a rental MFP is confirmed from user information of a rental destination. In the case of the owner change 803, user information to be changed and the wallet address of the MFP 131 to be rented are confirmed and, if it is the wallet address of the MFP 131, the owner change is OK. Otherwise, it means that the owner will be changed to an invalid MFP or user, and so, the owner change is NG.

In step S1003, if it is determined that the transmission destination wallet has the capability to make a payment, the smart contract 122 determines that the owner change is OK (YES) and transitions to step S1004, and if it is determined that the owner change is NG (NO), the smart contract 122 transitions to step S1007. In step S1004, the smart contract 122 generates the block 822 for which the purchase has been made or the block 823 for which the owner has been changed and adds it to the blockchain. Further, if the owner change is a shift from the wallet address of the information processing apparatus 132 of the user 130, who made the purchase, to the wallet address of the MFP 131, a change date and time is added as a rental start date and time to the block 823 to be generated. In step S1005, the smart contract 122 determines whether the block 822 or 823 for which the owner has been changed has been successfully added to the blockchain. If the block has been successfully added, the processing transitions to step S1006, and if the block has not been successfully added to the blockchain, the processing transitions to step S1007.

In step S1006, the smart contract 122 transmits a response that the NFT purchase or the owner change has been successful to the transmission source and ends the processing of this flowchart. Meanwhile, in step S1007, the smart contract 122 transmits a response that the NFT purchase or the owner change has not been successful to the transmission source and ends the processing of this flowchart.

Here, the processing of the smart contract 122 at the time of NFT purchase or owner change has been described. By thus processing for changing the owner being controlled in the smart contract 122, the MFP 131 can easily obtain a rental start date and time and timings at which to start monitoring the number of printed sheets of the MFP 131 and enable the print function of the MFP 131. Further, by storing an owner change date and time in a state variable that can be referenced from the smart contract 122 and in a storage region on a URI, the rental company 100 can be aware of a usage status related to the MFP 131 of the user 130, who concluded a rental contract.

### <Smart Contract: Print Count Notification>

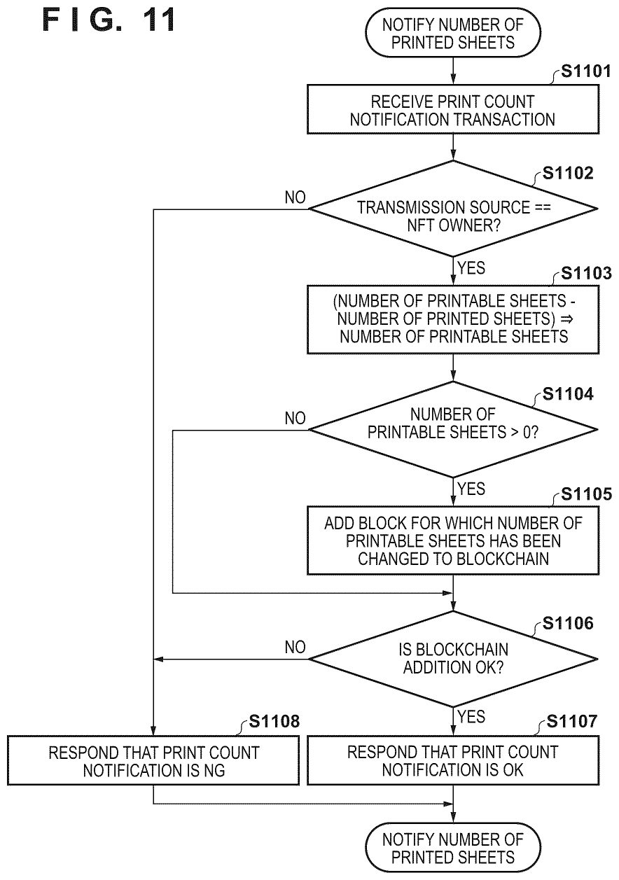

Next, a processing procedure for a print count notification from the MFP 131 using the smart contract 122 will be described with reference to FIG. 11.

In step S1101, the smart contract 122 receives the print count notification 804 (number of printed sheets 100 in color) or the print count notification 805 (number of printed sheets 900 in color) as a print count notification transaction block. In step S1102, the smart contract 122 confirms a transmission source and NFT owner information of the print count notification 804 or 805 and, if the addresses are the same, transitions to step S1103 and, if they are different, transitions to step S1108.

In step S1103, the smart contract 122 subtracts the number of printed sheets notified in the notification of the number of printed sheets (step S505) from the number of printable sheets and stores it as a new number of printable sheets in a status variable of the smart contract 122. Further, the smart contract 122 transmits the new number of printable sheets to the MFP 131 as a response for the print count notification 804. For example, if the print count notification 804 of the present embodiment is received, the number of printable sheets will be stored as 900. Meanwhile, if the print count notification 805 is received, the number of printable sheets will be stored as 0.

In step S1104, the smart contract 122 determines whether the number of printable sheets is greater than 0 and, if it is greater than 0, transitions to step S1105 and, if it is less than or equal to 0, transitions to step S1106. In step S1105, a block for which the number of printable sheets has been changed is added to the blockchain 120, and the processing transitions to step S1106. In step S1106, the smart contract 122 determines whether the block has been added to the blockchain 120 and, if the addition is OK, transitions to step S1107 and, if the addition is NG, transitions to step S1108.

In step S1107, the smart contract 122 transmits a print count notification OK response to the transmission source of the print count notification 804 and ends the processing of this flowchart. Meanwhile, in step S1108, the smart contract 122 transmits a print count notification NG response to the transmission source of the print count notification and ends the processing of this flowchart.

The smart contract 122 updates the number of printable sheets of an NFT and stores it on the blockchain 120 by executing processing according to the flowchart of FIG. 11, and thereby, it is possible to manage the number of printed sheets of the MFP 131 using an NFT in which the number of printable sheets has been set. By starting the rental of the MFP 131 according to the flowchart for owner change of FIG. 10 and managing the history of the number of printed sheets according to the flowchart of FIG. 11, it is possible to construct a system for renting an MFP using an NFT in which the number of printable sheets has been set. In addition to the number of printed sheets, the smart contract 122 can manage various consumables and consumable materials by providing lifespan data of each component as a state variable.

<Sequence from NFT Issuance to End of Rental>

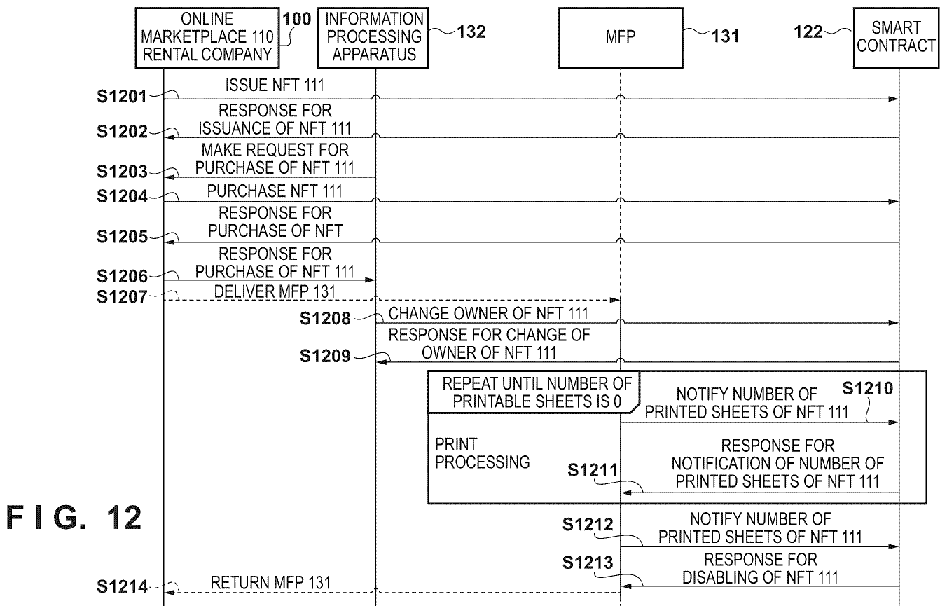

Next, an overall sequence according to the present embodiment from issuance of an NFT and enabling of a print function of a rental MFP to the end of rental will be described with reference to FIG. 12.

In step S1201, the online marketplace 110 transmits the issuance 801 for issuing the NFT 111 to the smart contract 122. In step S1202, the smart contract 122 transmits an NFT issuance response for the issuance 801 to the online marketplace 110. Once the NFT 111 has been issued, the online marketplace 110 starts selling the NFT 111 on the online marketplace 110.

In step S1203, in order to purchase a rental MFP service according to the NFT 111, the information processing apparatus 132 transmits a request for purchasing the NFT 111 to the online marketplace 110 according to an operation instruction of the user 130. In step S1204, the online marketplace 110 transmits a purchase of the NFT 111 to the smart contract 122. In step S1205, the smart contract 122 transmits an NFT purchase response to the online marketplace 110. Then, in step S1206, the online marketplace 110 transmits a response for the purchase of the NFT 111 to the information processing apparatus 132. Here, the owner of the NFT 111 is changed to the wallet address of the information processing apparatus 132.

Next, in step S1207, the online marketplace 110 performs and implements a procedure for delivering the MFP 131 to the user 130 of the information processing apparatus 132 with the purchase response of step S1205 as a trigger. In step S1208, the information processing apparatus 132 communicates with the MFP 131, obtains the wallet address of the MFP 131, and transmits the owner change 803 to the smart contract 122 for changing the owner of the NFT 111. In step S1209, the information processing apparatus 132 receives, from the smart contract 122, a response for the owner change of the NFT 111 for which the owner of the NFT 111 has been changed to the MFP 131. At this timing, the MFP 131 becomes the owner of the NFT 111, and the print function becomes enabled.

In step S1210, in the case of executing printing using the enabled print function, the MFP 131, transmits a print count notification to the smart contract 122 using the NFT 111. In step S1211, the smart contract 122 transmits a print count notification response to the MFP 131. Steps S1210 and S1211 are repeated until the number of printable sheets of the NFT 111 is reached.

Then, in step S1212, the MFP 131 transmits a print count notification for the NFT 111 to the smart contract 122, and the number of printable sheets of the smart contract 122 becomes 0. At this timing, the NFT 111 is disabled. Next, in step S1213, the smart contract 122 transmits that the NFT 111 has been disabled to the MFP 131 using a response of disabling of the NFT 111. The user 130 ends the rental contract of the MFP 131 by returning the MFP 131, which has been disabled by the disable response, to the rental company 100.

Here, the flow of the rental MFP system in which the number of printable sheets is set using the smart contract 122 has been described. As described above, a rental company can manage the number of printed sheets of an MFP rented to a user using the smart contract 122 and automatically enable or disable the print function of the MFP until the number of printable sheets is reached. Further, regarding a rental start date, by the owner of the NFT 111 being shifted to the MFP 131, it is possible to set a rental start date. Further, in the case of providing a rental period, it can be realized simply by adding, to step S1104, processing for determining a rental start date and a rental end date in the smart contract 122 and determining whether it is the rental end date at the time of notifying the number of printed sheets of the NFT 111. As described above, it is possible to construct an NFT-based MFP rental system by providing various conditions using a smart contract.

As described above, the printing apparatus according to the present embodiment is provided as a printing apparatus for rental managed on a blockchain network. The printing apparatus obtains a non-fungible token (NFT), which includes a right to print a predetermined number of sheets in a printing apparatus, via a smart contract and enables a print function of the printing apparatus. Further, the printing apparatus determines, via the smart contract, whether the number of sheets to be printed obtained from the print settings of an accepted print job is within a range of the number of printable sheets based on the obtained NFT. Regarding the printing apparatus, if the number of sheets to be printed is within the range of the number of printable sheets, the printing apparatus, which has been rented, executes printing using the obtained NFT. Accordingly, according to the present embodiment, it is possible to provide a mechanism for suitably managing the use of a printing apparatus on a blockchain network in a printing apparatus rental system. For example, it is possible to stop a print function of an MFP and end rental at a timing at which the number of printable sheets reaches 0.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-110259, filed Jul. 4, 2023, which is hereby incorporated by reference herein in its entirety.

What is claimed is:

1. A printing apparatus managed on a blockchain network, the printing apparatus comprising:
one or more memory devices that store a set of instructions; and
one or more processors that execute the set of instructions to:
obtain, a non-fungible token (NFT) that includes a right to print a predetermined number of sheets in the printing apparatus;
enable a print function of the printing apparatus;
determine whether the number of sheets to be printed obtained from a print setting of an accepted print job is within a range of the number of printable sheets based on the obtained NFT; and
in a case where the number of sheets to be printed is within the range of the number of printable sheets, execute printing in the printing apparatus using the obtained NFT.

2. The printing apparatus according to claim 1, wherein
execution of the instructions further configures the one or more processors to:
in a case where the number of sheets to be printed is not within the range of the number of printable sheets, disable the print function.

3. The printing apparatus according to claim 1, wherein
execution of the instructions further configures the one or more processors to:
in a case where the number of sheets to be printed is not within the range of the number of printable sheets, display, on a display, a screen that includes a message indicating that printing cannot be executed and an object for instructing an additional purchase of an NFT.

4. The printing apparatus according to claim 3, wherein
execution of the instructions further configures the one or more processors to:
display, as the object for instructing the additional purchase of the NFT, at least one of an object for making a new purchase and an object for changing an owner of an already purchased NFT.

5. The printing apparatus according to claim 1, wherein
execution of the instructions further configures the one or more processors to:
transmit, to the blockchain network, a transaction block indicating a print result including the number of printed sheets for which printing has been executed.

6. The printing apparatus according to claim 5, wherein
execution of the instructions further configures the one or more processors to:
obtain, from a block of the blockchain network the number of printable sheets, which has been updated based on the print result, as a response for the print result.

7. The printing apparatus according to claim 6, wherein
execution of the instructions further configures the one or more processors to:
in a case where the updated number of printable sheets obtained from the block of the blockchain network as the response for the print result is zero sheets, disable the print function.

8. The printing apparatus according to claim 1, wherein
execution of the instructions further configures the one or more processors to:
change an owner of the NFT, which has been purchased in an external apparatus, to the printing apparatus and obtain the NFT.

9. The printing apparatus according to claim 8, wherein
the NFT is purchased using a wallet address of the printing apparatus.

10. The printing apparatus according to claim 2, wherein
the number of printable sheets is set for color printing and monochrome printing, respectively.

11. The printing apparatus according to claim 10, wherein
execution of the instructions further configures the one or more processors to:
as the print function, disable or enable color print and monochrome print functions, respectively.

12. A method of controlling a printing apparatus managed on a blockchain network, the method comprising:
obtaining a non-fungible token (NFT) that includes a right to print a predetermined number of sheets in the printing apparatus;
enabling a print function of the printing apparatus;
determining whether the number of sheets to be printed obtained from a print setting of an accepted print job is within a range of the number of printable sheets based on the obtained NFT; and
in a case where the number of sheets to be printed is within the range of the number of printable sheets, executing printing in the printing apparatus, which has been rented, using the obtained NFT.

13. A non-transitory computer-readable storage medium storing a computer program for causing a computer to execute each step of a method of controlling a printing apparatus managed on a blockchain network, the method comprising:
obtaining a non-fungible token (NFT) that includes a right to print a predetermined number of sheets in the printing apparatus;
enabling a print function of the printing apparatus;
determining whether the number of sheets to be printed obtained from a print setting of an accepted print job is within a range of the number of printable sheets based on the obtained NFT; and
in a case where the number of sheets to be printed is within the range of the number of printable sheets, executing printing in the printing apparatus, which has been rented, using the obtained NFT.

14. A system operable to provide a printing apparatus to be managed on a blockchain network, the system comprising:
one or more memory devices that store a set of instructions; and
one or more processors that execute the set of instructions to:
issue a non-fungible token (NFT) that includes a right to print a predetermined number of sheets in the printing apparatus;
obtain the issued NFT;
enable a print function of the printing apparatus;
determine whether the number of sheets to be printed obtained from a print setting of an accepted print job is within a range of the number of printable sheets based on the obtained NFT; and
in a case where the number of sheets to be printed is within the range of the number of printable sheets, execute printing in the printing apparatus, which has been rented, using the obtained NFT.
